(19) United States
(12) Patent Application Publication
(10) Pub. No.: US 2020/0047882 A1
(43) Pub. Date: Feb. 13, 2020

(54) DISASTER RESPONSE ROBOT CAPABLE OF UPDATING DISASTER SCENE MAP AND INTENSIVELY RESPONDING TO HOTSPOT AREA, AND CONTROL DEVICE THEREFOR

(71) Applicant: KOREA INSTITUTE OF ROBOT AND CONVERGENCE, Pohang-si (KR)

(72) Inventors: JINHO SUH, Pohang-si (KR); KAP-HO SEO, Pohang-si (KR); SEUNGSUB OH, Pohang-si (KR); JEHUN HAHM, Pohang-si (KR); KYON-MO YANG, Pohang-si (KR)

(73) Assignee: KOREA INSTITUTE OF ROBOT AND CONVERGENCE, Pohang-si (KR)

(21) Appl. No.: 16/105,996

(22) Filed: Aug. 21, 2018

(30) Foreign Application Priority Data
Aug. 8, 2018 (KR) 10-2018-0092463
Aug. 8, 2018 (KR) 10-2018-0092468

(51) Int. Cl. B64C 39/02; G05D 1/00; G06F 17/30; H04W 48/16

(52) U.S. Cl. CPC B64C 39/024; G05D 1/0011; G05D 1/0088; G06F 17/30241; G06F 17/30377; B64C 2201/146; B64C 2201/024; B64C 2201/123; B64C 2201/127; B64C 2201/141; H04W 48/16

(57) ABSTRACT

A disaster response robot includes: a disaster scene map storing module configured to store the disaster scene map; an autonomous driving module configured to perform autonomous driving based on the disaster scene map; a manual driving route receiving module configured to receive a manual driving route from a control device for an area; a manual driving module configured to perform manual driving; an investigation information real-time collecting module configured to collect investigation information during the autonomous driving performed by the autonomous driving module and the manual driving performed by a manual driving module; and an investigation information transmitting module configured to transmit the investigation information collected in real time by the investigation information real-time collecting module to the control device.

### CROSS-REFERENCE TO RELATED APPLICATIONS

This application claims the priority of Korean Patent Application Nos. 10-2018-0092463 filed on Aug. 8, 2018, and 10-2018-0092468 filed on Aug. 8, 2018, which are all hereby incorporated by reference in their entirety.

### ACKNOWLEDGEMENTS

This work funded by the Korea Evaluation Institute of Industrial Technology (KEIT) and the Ministry of Trade, Industry and Energy (MOTIE), the Republic of Korea. [Project Name: Development of Disaster Response Robot System for Lifesaving and Supporting Fire Fighters at Complex Disaster Environment, Project No. 10067169]

### BACKGROUND

### 1. Field of the Invention

The present invention relates to a robot and a control device therefor, and more particularly to a disaster response robot capable of updating a disaster scene map and intensively responding to a hotspot area.

### 2. Description of the Prior Art

Conventionally, investigation drones or rescue robots are injected to a disaster scene to collect information. Investigation drones or rescue robots play rolls in fireplaces, mountain fire areas, and flood areas, which people cannot directly enter.

The existing drones or robots are often injected to disaster scenes, the structures of which have been known in advance. Further, various pieces of information may be collected by using various sensors based on the already known disaster scene structure.

However, the structures of the disaster scenes known in advance may be changed by a fire or the like. For example, the existing wall bodies in the disaster scenes may fall down so that the structures of the disaster scenes change, and obstacles may occur in the passages due to various structures. Further, complex structures that cannot be known may be discovered as the interiors thereof change.

Accordingly, it is necessary to promptly recognize the structures that change in real time and respond to disasters.

In the actual disaster scenes, there are areas in which disasters intensively occur or an important disaster response area in most cases, and intensive responses of firepersons or robots are required in the areas.

Further, there are many areas that cannot be directly identified by naked eyes as firepersons cannot enter the actual disaster scenes.

Even in this case, it is necessary for a robot such as a drone to make an initial investigation.

In this way, even in the disaster scenes, it is a very important issue to promptly recognize an area that requires an intensive response of a robot such as a drone.

### PRIOR TECHNICAL DOCUMENTS

### Patent Documents

Korean Patent No. 10-1468545

Korean Patent No. 10-1413475

### SUMMARY

The present invention provides a disaster response robot that investigates a disaster scene by using various sensors or performs a function such as a rescue of a rescue required person, and more particularly, provides a disaster response robot that may update a disaster scene map and a disaster response robot that may intensively response to a hotspot area.

The present invention also provides a control device that controls a disaster response robot that investigates a disaster scene by using various sensors or performs a function such as a rescue of a rescue required person, and more particularly, provides a control device for a disaster response robot that may update a disaster scene map and a control device that may intensively response to a hotspot area.

In accordance with an aspect of the present invention, there is provided a disaster response robot capable of updating a disaster scene map and intensively responding to a hotspot area, the disaster response robot including: a disaster scene map storing module configured to store the disaster scene map; an autonomous driving module configured to perform autonomous driving based on the disaster scene map stored in the disaster scene map storing module; a manual driving route receiving module configured to receive a manual driving route from a control device for an area, a structure of which has been changed or cannot be known on the disaster scene map based on an investigation result according to the autonomous driving; a manual driving module configured to perform manual driving such that an investigation information real-time collecting module collects investigation information according to the manual driving route received by the manual driving route receiving module; an investigation information real-time collecting module configured to collect investigation information during the autonomous driving performed by the autonomous driving module and the manual driving performed by a manual driving module; an investigation information transmitting module configured to transmit the investigation information collected in real time by the investigation information real-time collecting module to the control device; a hotspot information receiving module configured to receive information on a hotspot and a hotspot mission in the corresponding hotspot from the control device; and a hotspot mission performing module configured to perform a hotspot mission in the hotspot according to the received information.

The investigation information real-time collecting module may collect investigation information by using at least one of a visual sensor, a thick smoke sensor, an infrared ray sensor, a radar sensor, and a microphone.

The investigation information real-time collecting module may collect investigation information for changing a structure of the disaster scene map and updating the disaster situation in real time.

The hotspot may be an area that intensively requires a disaster response in the disaster scene.

In accordance with another aspect of the present invention, there is provided a control device capable of updating a disaster scene map and intensively responding to a hotspot area, the disaster response robot including: a disaster scene map database configured to store a disaster scene map in advance; a disaster scene map transmitting module configured to transmit the disaster scene map stored in the disaster scene map data base in advance to an update mission performing robot; a manual driving route input module configured to receive a manual driving route from a control person for an area, a structure of which has been changed or cannot be known on the disaster scene map based on an investigation result according to the autonomous driving; a manual driving route receiving module configured to transmit the manual driving route received by the manual driving input module to the update mission performing robot; an investigation information receiving module configured to receive the investigation information collected by the update mission performing robot to update a disaster scene map during autonomous driving or manual driving from the update mission performing robot; a disaster scene map update module configured to update the disaster scene map stored in the disaster scene map database by using the investigation information received by the investigation information receiving module; a hotspot setting module configured to set a hotspot based on the disaster scene map updated by the disaster scene map update module; a hotspot mission setting module configured to set a hotspot mission in the hotspot set by the hotspot setting module; and a hotspot information receiving module configured to transmit information on the hotspot set by the hotspot setting module and the hotspot mission set by the hotspot mission setting module to the disaster response robot.

The investigation information receiving module may receive the investigation information collected by using at least one of a visual sensor, a thick smoke sensor, an infrared ray sensor, a radar sensor, and a microphone, which was provided to the disaster response robot in advance.

The investigation information receiving module may receive investigation information for changing a structure of the disaster scene map and updating the disaster situation.

The hotpot may be an area that intensively requires a disaster response in the disaster scene.

### BRIEF DESCRIPTION OF THE DRAWINGS

The above and other objects, features and advantages of the present invention will be more apparent from the following detailed description taken in conjunction with the accompanying drawings, in which:

FIG. 1 is a system diagram of a disaster response robot capable of updating a disaster scene map and intensively responding to a hotspot area, and a control device therefor according to an embodiment of the present invention;

FIG. 2 is a block diagram of a disaster response robot capable of updating a disaster scene map and intensively responding to a hotspot area according to an embodiment of the present invention; and

FIG. 3 is a block diagram of a control device capable of updating a disaster scene map and intensively responding to a hotspot area according to an embodiment of the present invention.

### DETAILED DESCRIPTION

The present invention may be variously modified and may have various forms, and specific embodiments thereof will be illustrated in the drawings and described in detail. However, the present invention is not limited to specific disclosed forms, but it is understood that the scope of the present invention include all changes pertaining to the spirit and technical scope of the present invention, equivalents or replacements thereof. In the drawings, the same or like reference numerals denote the same or like elements.

The terms such as first, second, A, and B may be used to describe various elements, but the elements are not limited to the terms. The terms may be used only for the purpose of distinguishing one element from another element. For example, without departing the scope of the present invention, a first element may be referred to as a second element, and similarly, a second element may be referred to as a first element. The term of and/or includes a combination of a plurality of related items described or any one of a plurality of related items described.

When it is mentioned that one element is “connected to” or “electrically connected to” another element, it should be understood that the first element may be directly connected or electrically connected to the second element but a third element may be provided therebetweeen. On the other hand, when it is mentioned that an element is “directly connected to” or “directly electrically connected to” another element, it should be understood that a third element is not present between them.

The terminologies used herein are provided only to describe specific embodiments, and are not intended to limit the present invention. The terms of a singular form may include plural forms unless otherwise specified. The terms “including” and “having” are used to designate that the features, the numbers, the steps, the operations, the elements, the parts, or combination thereof described in the specification are present, and may be understood that one or more other features, numbers, step, operations, elements, parts, or combinations thereof may be added.

In addition, unless defined otherwise, all terms used herein, including technical or scientific terms, have the same meanings as those generally understood by those skilled in the art to which the present invention pertains. The terms defined in the generally used dictionaries should be construed as having the meanings that coincide with the meanings of the contexts of the related technologies, and should not be construed as ideal or excessively formal meanings unless clearly defined in the specification of the present invention.

Hereinafter, exemplary embodiments of the present invention will be described in detail with reference to the accompanying drawings.

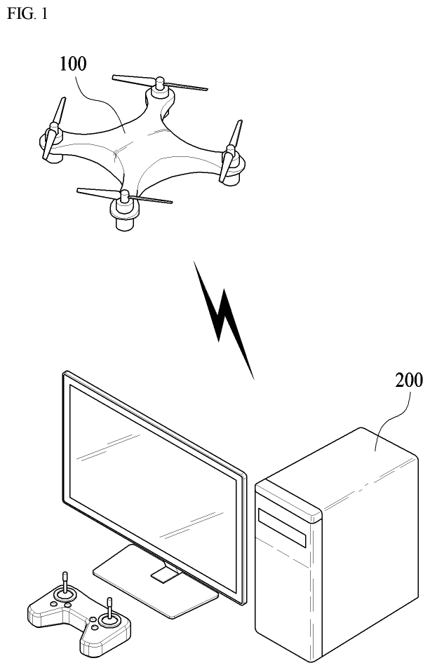

FIG. 1 is a system diagram of a disaster response robot capable of updating a disaster scene map and intensively responding to a hotspot area, and a control device therefor according to an embodiment of the present invention.

The system of FIG. 1 may include a disaster response robot 100 and a control device 200 that controls the disaster response robot 100.

The disaster response robot 100 may be injected to a disaster scene under the control of the control device 200 to collect various pieces of disaster information and provide the collected disaster information to the control device 200. For example, the disaster response robot 100 may collect visual information of a disaster scene to transmit the collected visual information to the control device 200 or detect main rescue required person information of the disaster scene to provide the detected main rescue required person information to the control device 200.

The disaster response robot 100 may collect investigation information of the disaster scene in real time, and the control device 200 may update a disaster scene map in real time by using the investigation information and designate a specific area as a hotspot area in real time. The disaster response robot 100 may intensively respond to a disaster in the hotspot area.

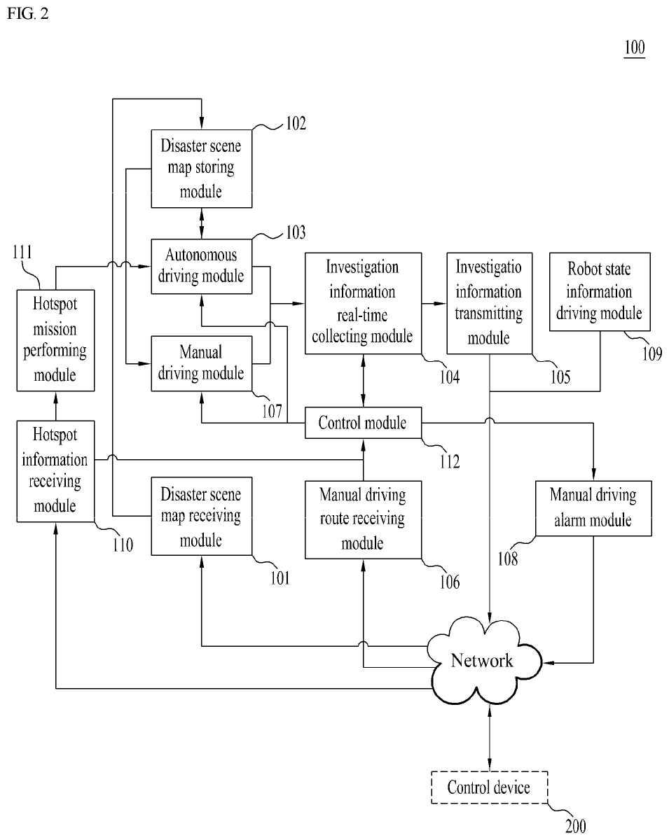

FIG. 2 is a block diagram of a disaster response robot capable of updating a disaster scene map and intensively responding to a hotspot area according to an embodiment of the present invention.

Referring to FIG. 2, the disaster response map 100 may include a disaster scene map receiving module 101, a disaster scene map storing module 102, an autonomous driving module 103, an investigation information real-time collecting module 104, an investigation information transmitting module 105, a manual driving route receiving module 106, a manual driving module 107, a manual driving alarm module 108, a robot state information transmitting module 109, a hotspot information receiving module 110, a hotspot mission performing module 111, and a control module 112.

The disaster response module 100 may be initially injected to a disaster scene to update a structure change item of the disaster scene, which has been known already, and a disaster situation in real time.

The disaster response robot 100 may update the disaster scene map, which has been secured in the disaster scene, such as a fire site, in real time to use the updated disaster scene map to response the disaster.

The disaster response robot 100 may preferentially perform a mission in a hotspot that intensively requires a response to a disaster or preferentially requires performance of a mission by a robot according to a disaster scene situation.

The hotspot and the mission for the hotspot may be set by collecting investigation information collected by the control device 200, and the disaster response robots 100 may share their hotspot missions to cooperate with each other. According to necessities, the disaster response robot 100 also may cooperate with firepersons who are injected to the hotspot.

The disaster response robot 100 may include a drone or a ground robot.

Hereinafter, a detailed configuration will be described.

The disaster scene map receiving module 101 may receive a disaster scene map from the control device 200. Here, the disaster scene may be an indoor or outdoor site. The disaster scene map may be a map on an indoor interior structure, such as a building or a large-scale warehouse, and may be a map on an outdoor structure, such as a hill or a harbor.

The disaster scene map storing module 102 may store the disaster scene map received from the disaster scene map receiving module 101.

The autonomous driving module 103 may be autonomously driven without a remote control of a control person by using an autonomous driving function. The autonomous driving module 103 may perform autonomous driving based on the disaster scene map stored in the disaster scene map storing module 102.

The autonomous driving module 103 may automatically sets an autonomous driving route through a path of the disaster scene map, and may perform primary autonomous driving on the autonomous driving route.

The investigation information real-time collecting module 104 may connect investigation information in real time by using various sensors during autonomous driving of the autonomous driving module 103.

The investigation information real-time collecting module 104 may collect investigation information for changing the structure of the disaster scene map or updating the disaster situation.

The investigation information real-time collecting module 104 may move rapidly without collecting investigation information for mapping for a path, a point, or an area that is the same as that of the structure on an existing disaster scene map, and may collect investigation information for mapping for a path, a point, or an area that is different from that of the structure on the disaster scene map as investigation information for mapping.

Accordingly, the disaster scene map may be updated by scanning the disaster scene differently from in a simultaneous localization and map-building (or simultaneous localization and mapping) (SLAM).

In more detail, the autonomous driving module 103 may rapidly scan and determine whether another route or structure is the same as the route or structure at the same point on the existing disaster scene map from the investigation information collected by the investigation information real-time collecting module 104. If they are the same according to the determination result, the autonomous driving module 103 may rapidly pass through the corresponding point or route. The autonomous driving module 103 may collect the investigation information for mapping for the corresponding point more finely if the route or structure of the point based on the current investigation information is different from the route or structure of the point on the disaster scene map according to the determination result.

The investigation information real-time collecting module 104 may detect a disaster situation, for example, presence of a rescue required person, a location of the rescue required person, a thick smoke state, or a fire state in detail by using the sensors.

That is, the investigation information real-time collecting module 104 includes a visual sensor, a thick smoke sensor, an infrared ray sensor, a radar sensor, and a microphone to collect various pieces of investigation information by using them.

The investigation information transmitting module 105 may transmit the investigation information collected by the investigation information real-time collecting module 104 to the control device 200.

The investigation information transmitting module 105 may associate investigation information with an investigation information collection location at which the investigation information is collected and transmit the associated information to the control device 200. The investigation information collection location may be location information based on the disaster scene map.

The disaster scene may be in a communication disabled state due to various complex structures and the disaster situation. In this way, when the communication state of the investigation information transmitting module 105 is disabled during primary autonomous driving, the investigation information transmitting module 105 may associate the investigation information collected in real time by the investigation information real-time collecting module 104 with the corresponding autonomous driving route and accumulate and store the associated information in real time when the autonomous driving is continued.

If the communication state of the investigation information transmitting module 105 returns to a normal state, the investigation information transmitting module 105 may collectively transmit the investigation information that is accumulated and stored in real time in association with the autonomous driving route to the control device 200.

The manual driving route receiving module 106 may receive a manual driving route from the control device 200. The manual driving route is a real-time driving route that is manually set by a control person, and may be generated in real time during manual driving by a remote control of the control person.

The manual driving module 107 may perform secondary manual driving according to a manual driving route corresponding to a remote control of the control person.

The manual driving module 107 may perform secondary manual driving in a complex area, the structure of which cannot be recognized, or an area in which disasters, such as a fire, are intensively generated according to a change of an interior, after rapidly performing an investigation based on an existing disaster scene map through the primary autonomous driving.

The investigation information real-time collecting module 104 may collect investigation information in real time during secondary manual driving, and the investigation information transmitting module 105 may transmit the investigation information collected during the secondary manual driving to the control device 200 in real time.

The manual driving alarm module 108 may provide an alarm message to the control device 200 at a remote site during the secondary manual driving by the manual driving module 107.

When the investigation information real-time collecting module 104 detects a situation for setting an obstacle, a branch point or other various secondary manual driving routes, the manual driving alarm module 108 may provide an alarm message while transmitting the corresponding investigation information to the control device 200 in real time. Accordingly, the control person at the remote site may accurately determine and set the manual driving route.

The manual driving route receiving module 106 may receive a manual driving route from the control device 200 in response to the alarm message.

The robot state information transmitting module 109 may transmit state information of the disaster response robot 100 to the control device 200 in real time or periodically. The state information may be information on the state of charge of the battery of the disaster response robot 100, the consumption speed of the battery, and whether various sensors are normally operated.

The robot state information transmitting module 109 may transmit the state information to the control device 200 to allow the control device 200 to monitor the state of the disaster response robot 100. The control device 200 may set the ranges of the hotspots of the disaster response robots 100 and the missions of the hotspots by using the state information.

The hotspot information receiving module 110 may receive information on a hotspot and a hotspot mission in the corresponding hotspot from the control device 200.

Here, the hotspot may be an area that requires injection of a robot, such as a drone, as it is an area which a fireperson cannot enter in the disaster scene, an area that requires an intensive disaster response even though it is an area which a fireperson may enter, and may be an area that requires an intensive rescue mission because it is an area of many rescue required persons.

Further, the hotspot mission may be a mission that is allocated to the disaster response robot 100 in the corresponding hotspot. The hotspot mission may be a mission that is preferentially reallocated to a mission that has been already performed by the disaster response robot 100.

Because several disaster response robots 100 are often injected to the hotspot at the same time, the hotspot mission may allow the disaster response robots 100 to share their missions such that their missions may be recognized by the disaster response robots 100 and the disaster response robots 100 may cooperate with each other.

The hotspot mission performing module 111 may perform a hotpot mission according to the hotspot information received by the hotspot information receiving module 110.

The hotspot mission may be variously set as a visual mission, a thick smoke detection mission, a rescue required person detection mission, a mapping mission, a rescue required person escape path guide mission, and a communication relay mission.

The hotspot mission performing module 111 may perform a hotspot mission in a hotspot prior to a mission that is performed currently.

Prior to that, the hotspot mission performing module 111 may control the autonomous driving module 103 such that the autonomous driving module 103 may promptly move from the current location to the hotspot.

The hotspot mission performing module 111 may perform a personal hotspot mission or perform a hotspot mission that is cooperated with another disaster response robot 100 of the hotspot or a fireperson.

The control module 112 may collectively control the operations of the configurations. The control module 112 may control several configurations such that the configurations interwork with each other when various situations and conditions occur.

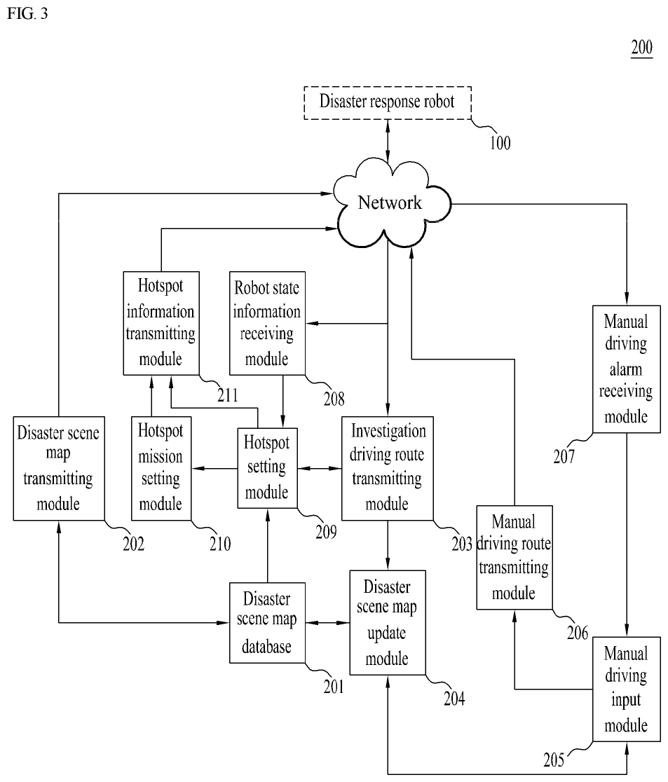

FIG. 3 is a block diagram of a control device capable of updating a disaster scene map and intensively responding to a hotspot area according to an embodiment of the present invention.

Referring to FIG. 3, the control device 200 may include a disaster scene map database 201, a disaster scene map transmitting module 202, an investigation information receiving module 203, a disaster scene map update module 204, a manual driving input module 205, a manual driving route transmitting module 206, a manual driving alarm receiving module 207, a robot state information receiving module 208, a hotspot setting module 209, a hotspot mission setting module 210, and a hotspot information transmitting module 211.

The control device 200 may receive investigation information of a disaster scene map from several disaster response robots 100 injected to the disaster scene to update the disaster scene map.

The control device 200 may update both a structural change of the disaster scene and a real-time change of the disaster situation in the disaster scene map to respond to the disaster.

The control device 200 may set an area which a fireperson cannot easily enter or an area that intensively requires a disaster response as a hotspot based on the update information of the disaster scene map and various investigation information and inject the disaster response robot 100.

The control device 200 may set hotspot missions for the disaster response robots 100 injected to the hotspots and may controls the disaster response robots 100 to cooperate with each other while sharing missions if necessary.

Hereinafter, a detailed configuration will be described.

The disaster scene map database 201 may store a disaster scene map for various indoor/outdoor disaster scenes, such as buildings, mountains, parks, and harbors, in advance.

The disaster scene map transmitting module 202 may transmit the disaster scene map stored in the disaster scene map database 201 in advance to a robot or a drone injected to the corresponding disaster scene.

The investigation information receiving module 203 may receive investigation information from the disaster response robot 100. Here, the investigation information receiving module 203 also may receive the corresponding investigation information collection location together with the investigation information.

As mentioned above, the investigation information may include information on a change item based on a structural change of the disaster scene map and a disaster situation of the disaster scene.

The investigation information receiving module 203 may receive investigation information from the several disaster response robots 100 injected to the disaster scene.

The disaster scene map update module 204 may update the disaster scene map stored in the disaster scene map database 201 in real time by using the investigation information received by the investigation information receiving module 203.

The disaster scene map update module 204 may update the disaster scene map by using the investigation information collected from the several disaster response robots 100 in the areas of the disaster scene, and may update the disaster situations of the zones, such as structure wall and obstacles, which have been changed from the disaster scene map. A wall that fell down or a structure wall that was not present originally may be newly added to a specific zone. Further, the fire situations, the thick smoke situations, the rescue required person situations, and the like may be updated in the disaster scene map in real time for the areas.

When the disaster scene map is updated by the disaster scene map update module 204, the disaster scene map transmitting module 202 may read the updated item from the disaster scene map database 201 and transmit the read item to the disaster response robot 100 of the disaster scene in real time.

The disaster response robot 100 may perform primary autonomous driving or set an autonomous driving route by using the disaster scene map updated in real time.

The manual driving input module 205 may receive an area, the internal structure of which has not been defined in the disaster scene map or an area, which is required to be investigated more accurately or the situation of which is required to be recognized, the area being set by the control person, and may receive a manual driving route for the second manual driving in the corresponding area from the control person in real time.

The manual driving route transmitting module 206 may transmit the area set by the control person in real time and the manual driving route input b the control person to the corresponding disaster response robot 100 in real time.

The manual driving alarm receiving module 207 may receive an alarm message from the disaster response robot 100. As mentioned above, the alarm message is a message that allows the disaster response robot 100 to inform that an obstacle or a branch point is captured during the second manual driving.

When the manual driving alarm receiving module 207 receives an alarm message, an alarm may be displayed on the display of the control device 200, and the manual driving input module 205 may receive a manual driving route from the control device in real time.

The control person may avoid an obstacle more easily to remotely control the manual driving or set a direction at the branch point by allowing the disaster response robot 100 to accurately recognize an obstacle or a branch point that may be recognized clearly through the display of the control device 20 by the control person through various sensors and inform the control person of the recognized obstacle or branch point.

The robot state information receiving module 208 may receive the robot state information from the disaster response robot 100 in real time or periodically.

The control device 200 may monitor the robot state information received by the robot state information receiving module 208.

The hotspot setting module 209 may set a hotspot based on the disaster scene map updated by the disaster scene map update module 240.

As mentioned above, the hotspot may be an area that requires injection of a robot, such as a drone, as it is an area which a fireperson cannot enter in the disaster scene, an area that requires an intensive disaster response even though it is an area which a fireperson may enter, and may be an area that requires an intensive rescue mission because it is an area of many rescue required persons.

The hotspot mission setting module 210 may set a hotspot mission in the hotspot set by the to hotspot setting module 209. Different hotspot missions may be set for the disaster response robots 100, and missions may be set to be divided such that the disaster response robots 100 may cooperate with each other.

The hotspot mission setting module 210 may set a disaster response robot 100 that will be injected to a hotspot first when the hotspot mission is set. Here, the robot state information received by the robot state information receiving module 208 may be used. The selection of the disaster response robot 100 may be determined after states of charge of the batteries of the disaster response robots 100 or whether an operational state of the device is normal are inquired in real time.

When the state of charge of the battery is high and a specific sensor is normally operated, a hotspot mission that requires a highest battery consumption of the disaster response robot 100 and uses the specific sensor may be allocated.

Further, when the state of charge of the battery is almost zero or a sensor or another function that will perform a hotspot mission is not normal, the disaster response robot will not be injected to the hotspot.

Optimum matching or a hotspot mission may be set by comparing the states of charge of the batteries, whether operations of the disaster response robots 100 are normal, and the natural functions of the disaster response robots 100 with the hotspot mission required by the hotspot currently.

As mentioned above, the hotspot mission may be variously set as a visual mission, a thick smoke detection mission, a rescue required person detection mission, a mapping mission, a rescue required person escape path guide mission, a communication relay mission, and a relay installation mission.

The missions that may be cooperated refer to missions that may be divided into a visual mission, a thick smoke detection mission, a rescue required person detection mission, and a relay mission, which will be performed. A relay mission refers to a mission, by which a specific disaster response robot 100 has to perform a communication relay mission when a direction communication is impossible as a distance between the control device 200 and the disaster response robot 100 is long or the internal structure of the disaster is complex. Further, the relay installation mission refers to a mission by which the disaster response robot 100, such as a drone, injects and installs a relay at a point that requires a relay due to a broken communication.

In this way, the hotspot mission setting module 210 may set the hotspot ranges and the hotspot missions of the disaster response robots 100 by using the robot state information.

Meanwhile, the hotspot mission setting module 210 may change and set the hotspot ranges and the hotspot missions in real time according to a disaster situation that changes over time, based on the investigation information collected in real time as well as the robot state information. The disaster situation may be a fire situation, a thick smoke situation, or a rescue required person situation.

The hotspot information transmitting module 211 may transmit information on the hotspot set by the hotspot setting module 209 and the hotspot mission set by the hotspot mission setting module 210 to the disaster response robot 100.

The hotspot mission setting module 210 may reset the hotspot mission in real time according to the state changes of the disaster response robots 100 received in real time or periodically through the robot state information receiving module 208.

Because several disaster response robots 100 perform the hotspot missions in the same hotspot, it is possible to exchange the hotspot missions. Because the consumption speeds of the batteries may vary according to the hotspot missions, the hotspot mission may be identified and changed in real time for the disaster response robot 100, the battery consumption speed of which is high.

According to the disaster response robot capable of updating a disaster scene map and intensively responding to a hotspot area, and a control device therefor, an existing disaster scene map may be promptly updated and utilized by promptly detecting investigation information on an actual structure of a disaster scene and a disaster situation through autonomous driving of a robot (drone) by using a disaster scene map of a building or an outdoor site.

The control device may recognize a disaster situation by using investigation information of a drone and allow the injected robots (drones) to share the updated disaster scene map.

In particular, an accuracy of a disaster scene map and update efficiency may be improved by primarily performing autonomous driving and investigation by using an existing disaster scene map and secondarily performing manual driving and investigation based on the changed disaster scene map.

In addition, convenience of a manual driving manipulation of the control person and safety of manual driving may be secured by transmitting an alarm to the control person when an obstacle is detected during manual driving.

Meanwhile, the efficiency of a disaster response may be improved and a disaster may be promptly coped with by setting a hot spot that particularly requires a disaster response of a robot, such as a done, and setting cooperation missions of the robots.

A disaster may be promptly and intensively coped with and a response of a fireperson to a disaster may be supported by setting a hotspot and a hotspot mission based on various parameters, such as whether the fireperson has entered the hotspot, whether there is an area in which disasters intensively occurred, presence of investigation information, presence of a rescue required person, and state information of a robot.

Spreading-out of a disaster may be initially subdued and damage due to a response to a disaster may be minimized by allocating a hotspot and a hotspot mission and preferentially performing another mission such that a prompt optimum response may be made initially in an urgent disaster field.

Although the embodiments of the present invention has been described, it will be understood by an ordinary person in the art that the present invention may be variously corrected and modified without departing from the spirit of the present invention described in the claims.

What is claimed is:

1. A disaster response robot capable of updating a disaster scene map and intensively responding to a hotspot area, the disaster response robot comprising:
a disaster scene map storing module configured to store the disaster scene map;
an autonomous driving module configured to perform autonomous driving based on the disaster scene map stored in the disaster scene map storing module;
a manual driving route receiving module configured to receive a manual driving route from a control device for an area, a structure of which has been changed or cannot be known on the disaster scene map based on an investigation result according to the autonomous driving;
a manual driving module configured to perform manual driving such that an investigation information real-time collecting module collects investigation information according to the manual driving route received by the manual driving route receiving module;
an investigation information real-time collecting module configured to collect investigation information during the autonomous driving performed by the autonomous driving module and the manual driving performed by a manual driving module;
an investigation information transmitting module configured to transmit the investigation information collected in real time by the investigation information real-time collecting module to the control device;
a hotspot information receiving module configured to receive information on a hotspot and a hotspot mission in the corresponding hotspot from the control device; and
a hotspot mission performing module configured to perform a hotspot mission in the hotspot according to the received information.

2. The disaster response robot of claim 1, wherein the investigation information real-time collecting module collects investigation information by using at least one of a visual sensor, a thick smoke sensor, an infrared ray sensor, a radar sensor, and a microphone.

3. The disaster response robot of claim 1, wherein the investigation information real-time collecting module collects investigation information for changing a structure of the disaster scene map and updating the disaster situation in real time.

4. The disaster response robot of claim 1, wherein the hotspot is an area that intensively requires a disaster response in the disaster scene.

5. A control device capable of updating a disaster scene map and intensively responding to a hotspot area, the disaster response robot comprising:
a disaster scene map database configured to store a disaster scene map in advance;
a disaster scene map transmitting module configured to transmit the disaster scene map stored in the disaster scene map data base in advance to an update mission performing robot;
a manual driving route input module configured to receive a manual driving route from a control person for an area, a structure of which has been changed or cannot be known on the disaster scene map based on an investigation result according to the autonomous driving;
a manual driving route receiving module configured to transmit the manual driving route received by the manual driving input module to the update mission performing robot;
an investigation information receiving module configured to receive the investigation information collected by the update mission performing robot to update a disaster scene map during autonomous driving or manual driving from the update mission performing robot;
a disaster scene map update module configured to update the disaster scene map stored in the disaster scene map database by using the investigation information received by the investigation information receiving module;
a hotspot setting module configured to set a hotspot based on the disaster scene map updated by the disaster scene map update module;
a hotspot mission setting module configured to set a hotspot mission in the hotspot set by the hotspot setting module; and
a hotspot information receiving module configured to transmit information on the hotspot set by the hotspot setting module and the hotspot mission set by the hotspot mission setting module to the disaster response robot.

6. The disaster response robot of claim 5, wherein the investigation information receiving module receives the investigation information collected by using at least one of a visual sensor, a thick smoke sensor, an infrared ray sensor, a radar sensor, and a microphone, which was provided to the disaster response robot in advance.

7. The disaster response robot of claim 5, wherein the investigation information receiving module receives investigation information for changing a structure of the disaster scene map and updating the disaster situation.

8. The disaster response robot of claim 5, wherein the hotpot is an area that intensively requires a disaster response in the disaster scene.
